(19) United States
(12) Patent Application Publication
(10) Pub. No.: US 2002/0139767 A1
(43) Pub. Date: Oct. 3, 2002

(54) Sipping lid for baby bottles

(76) Inventor: Kari L. Budd, West Jordan, UT (US)

Correspondence Address: MALLINCKRODT & MALLINCKRODT, 10 EXCHANGE PLACE, SUITE 510, SALT LAKE CITY, UT, 84111, US

(21) Appl. No.: 10/112,476

(22) Filed: Mar. 28, 2002

Related U.S. Application Data
(60) Provisional application No. 60/280,034, filed on Mar. 30, 2001.

(51) Int. Cl. A61J 9/00; A61J 9/08

(52) U.S. Cl. 215/387; 215/11.1; 215/11.6

(57) ABSTRACT

The present invention is a sipping lid for attachment to standard size baby bottles of the type having a hollow body to contain a liquid to be consumed by an infant and an externally threaded upper portion. The sipping lid includes a cap portion having an internally threaded portion adapted to screw onto the externally threaded portion of the baby bottle. A rigid nipple is integral with the cap portion and has an end wall at a free end thereof distal from the cap portion. The nipple and the cap portion define an internal cavity of the sipping lid. A pair of small holes extend through the end wall into the internal cavity. The cap portion engages the externally threaded portion of the hollow body of the baby bottle providing a seal between the sipping lid and the baby bottle. The holes both enter the infant's mouth simultaneously such that air cannot freely enter the baby bottle until suction by the infant is released. The present invention also comprises a combination of the sipping lid and a standard size baby bottle of the type having a hollow body to contain a liquid to be consumed by an infant and an externally threaded upper portion.

### RELATED APPLICATION

This application claims priority of my co-pending U.S. Provisional Patent Application No. 60/280,034 filed Mar. 30, 2001.

### BACKGROUND OF THE INVENTION

1. Field

The invention is in the field of baby bottles and drinking cups for infants, and more particularly those which use low spilling or non-spilling sipping lids or covers.

2. State of the Art

When the parents feel that their baby is ready to transition from a traditional baby bottle and rubber nipple arrangement, the transition is typically made to a standard training cup having a sipping lid. These training cups are typically of a larger size or diameter than baby bottles and are thus difficult for infants to grasp and control during feeding.

The sipping lids of training cups typically have a rigid nipple which extends longitudinally offset from the centerline of the lid, having one or more rather large holes for drinking at the free end of the nipple. The sipping lids for training cups also have a vent hole positioned away from the nipple for allowing air to enter the cup as liquid is expelled therefrom. Such sipping lids for training cups typically require a built-in rubber valve or diaphragm to prevent excessive loss of liquid through the hole or holes should the sipping cup be upset or dropped. Such valves or diaphragm are difficult to clean thoroughly, often requiring a special brush or boiling to clean. Other such sipping lids for training cups do not have a valve and liquid is free to flow from the cup through holes when tipped or upset.

The transition from the traditional baby bottle and rubber nipple arrangement to a sipping cup is a rather large leap in skills for the baby, and much frustration (both on the part of the parents and the baby) is often the result. The cup is typically too large to be held conveniently and surely by the baby. Likewise, it is difficult for the baby (even with parental assistance) to regulate the amount of liquid exiting the cup to be consumed, resulting in feeding too quickly and resultant spills. Also, the cups are typically opaque and lack the liquid level lines of baby bottles which indicate how much liquid has been consumed by the baby, resulting in over/under feeding of the baby.

### SUMMARY OF THE INVENTION

The present invention is a sipping lid for attachment to standard size baby bottles of the type having a hollow body to contain a liquid to be consumed by an infant and an externally threaded upper portion. The sipping lid includes a cap portion having an internally threaded portion adapted to screw onto the externally threaded portion of the baby bottle. A rigid nipple is integral with the cap portion and has an end wall at a free end thereof distal from the cap portion. The nipple and the cap portion define an internal cavity of the sipping lid. A pair of small holes extend through the end wall into the internal cavity. The cap portion engages the externally threaded portion of the hollow body of the baby bottle providing a seal between the sipping lid and the baby bottle. The holes both enter the infant's mouth simultaneously such that air cannot freely enter the baby bottle until suction by the infant is released.

The present invention also is an infant sipping bottle device comprising the combination of the sipping lid and a standard size baby bottle of the type having a hollow body to contain a liquid to be consumed by an infant and an externally threaded upper portion.

### THE DRAWINGS

The best mode presently contemplated for carrying out the invention is illustrated in the accompanying drawings, in which:

FIG. 1 is a perspective view of an exemplary sipping lid according to the present invention as attached to a standard size baby bottle;

FIG. 2, an exploded perspective view of the sipping lid, the baby bottle, a sealing disk used for transport to prevent leaking, and a standard size nipple cover;

FIG. 3, a fragmentary longitudinal vertical sectional view of the sipping lid attached to the baby bottle, to a slightly enlarged scale, taken on the line 3-3 of FIG. 1 showing the threaded interface of the sipping lid to the baby bottle;

FIG. 4, a side elevational view of the sipping lid taken on the line 4-4 of FIG. 2 as separated from the baby bottle;

FIG. 5, a top plan view of the sipping lid taken on the line 5-5 of FIG. 4;

FIG. 6, a longitudinal vertical sectional view of the sipping lid taken on the line 6-6 of FIG. 5;

FIG. 7, a rear elevational view of the sipping lid taken on the line 7-7 of FIG. 5; and

FIG. 8, a longitudinal vertical sectional view of the sipping lid taken on the line 8-8 of FIG. 5.

### DETAILED DESCRIPTION OF THE ILLUSTRATED EMBODIMENTS

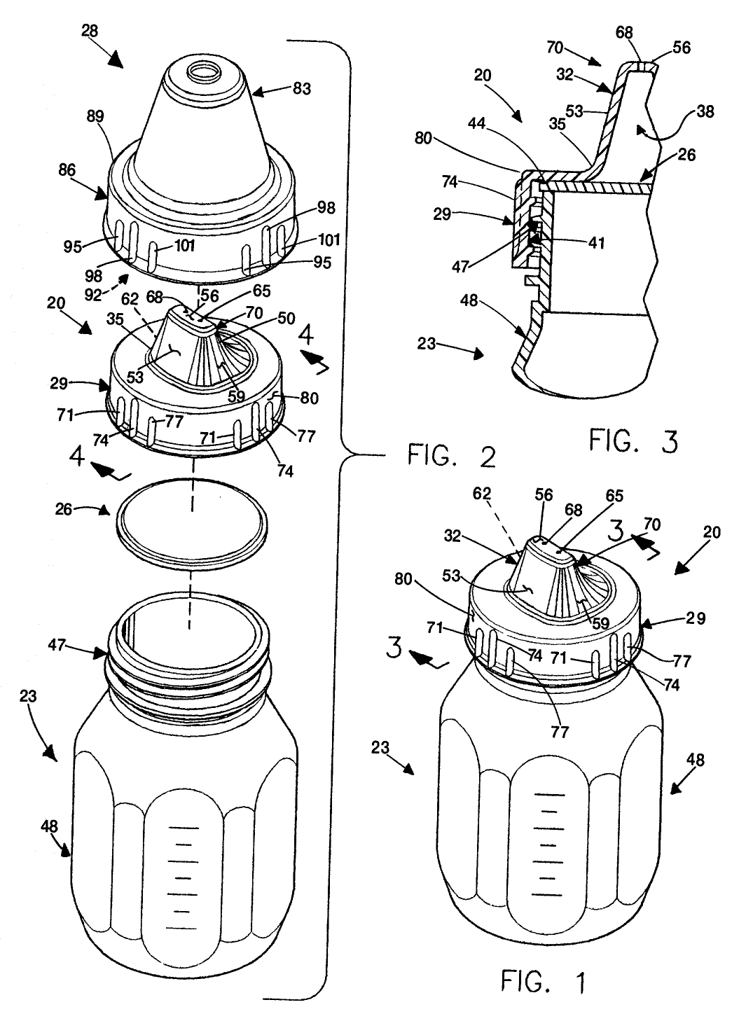

Referring to FIGS. 1 and 2, therein is shown an exemplary sipping lid according to the present invention, designated generally at 20, as attached to a standard size baby bottle 23 and using a sealing disk 26, and with a standard baby bottle nipple cover 28 used with rubber nipples (not shown) snap or frictionally fitting over sipping lid 20.

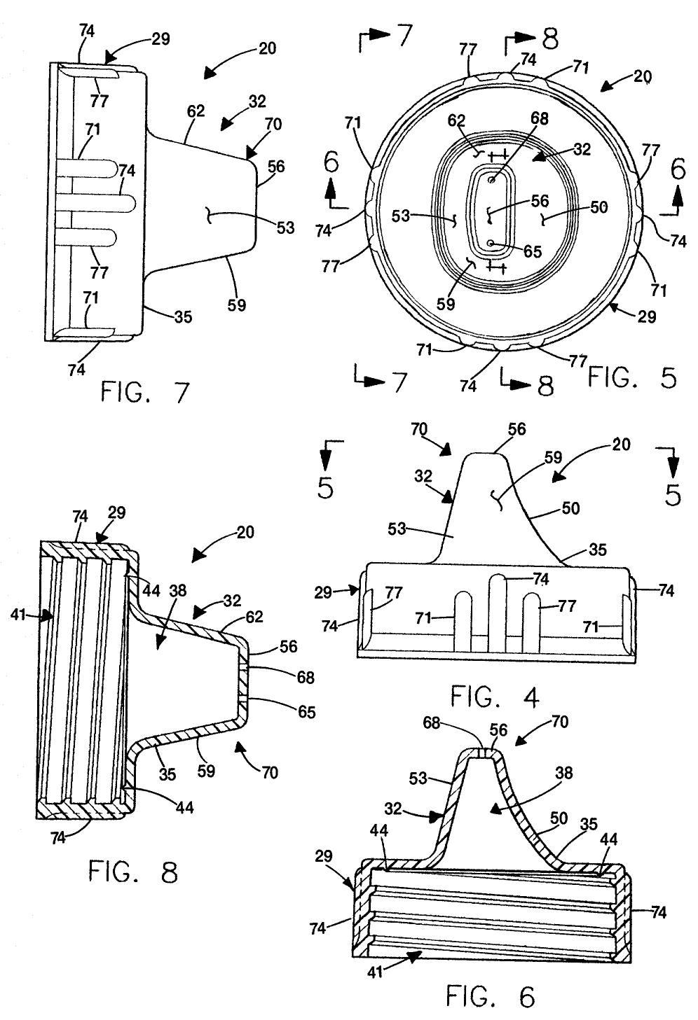

As best shown in FIGS. 1, and 4-8, the sipping lid 20 comprises a cap portion 29 and an integral rigid nipple 32, with an external wall 35 of the sipping lid 20 defining an internal cavity 38. Cap portion 29 is of such a size with an internally threaded portion 41 so as to screw fit onto the standard size baby bottle 23. Cap portion 29 includes an internal seal ring 44 which engages an externally threaded portion 47 of a hollow body 48 containing a liquid to be consumed by the infant of the baby bottle 23 thus providing a leak proof seal between the sipping lid 20 and the baby bottle 23. Nipple 32 is of a thin, curved configuration having a curved front wall 50, an angled, planar rear wall 53, a planar end wall 56, and a pair of angled, curved side walls 59 and 62 all of which smoothly blend together such that no sharp corners are produced and to comfortably fit into the mouth of an infant (not shown). Unlike prior art sipping lids, nipple 32 is generally centered on and extends longitudinally from the cap portion 29. A pair of small holes 65 and 68 extend through the end wall 56 at a free end 70 of nipple 32. The placement of nipple 32 is in a familiar position for the baby, being in the same position as the rubber nipple (not shown) used with the baby bottle 23 to which newborn babies are typically started on. Consequently, the nipple 32 is comfortable for the way the baby may already holds and use the baby bottle 23.

Holes 65 and 68 are of a diameter of about 1 mm, the diameter which permits sufficient liquid (not shown) to flow from the baby bottle 23 to the infant during use and return of air to the baby bottle 23 as liquid is removed therefrom, but minimizes the amount of liquid which can escape should the baby bottle 23 with attached sipping lid 20 be overturned or dropped. This feature is primarily due to the small size of holes 65 and 68, wherein combined effects of the surface tension of the water acting against nipple 32 at the sides of holes 65 and 68 to limit the exiting of water, and the limited size thereof for air to replace removed liquid, causing a partial vacuum within the baby bottle 23 as liquid exits so as to limit the total volume of liquid exiting therefrom. This arrangement of holes 65 and 68 eliminates the need for a separate vent hole to permit air to enter the baby bottle 32. Therefore, the close placement of holes 65 and 68 requires that both be in the infant's mouth simultaneously such that air cannot freely enter the baby bottle 23 as happens on prior art nipples through a separate vent hole usually placed somewhere away from the nipple and thus not within the baby's mouth. Rather, sipping lid 20 places both of the holes 65 and 68 within the infant's mouth requiring the infant to produce at least a minimal amount of vacuum or sucking action to cause liquid to flow rather than having a free flow which may cause choking. Having no vent hole also restricts the flow if the bottle 23 is dropped or tipped over.

Sipping lid 20 is adapted for use with the sealing disk 26 and with the nipple cover 28. Cap portion 23 includes a plurality of sets of ribs 71, 74, and 77 along an outer periphery 80 of cap portion 29 which are for aiding in gripping the sipping lid 20 in hand during tightening and loosening from the baby bottle 23, and for engaging the nipple cover 28. Sipping lid 20 is designed to engage the standard nipple cover 28 of the type having a frustoconical upper cover 83 and a lower cap receiving portion 86, an outer wall 89 thereof defining an internal nipple receiving cavity 92. Cap receiving portion 86 includes a plurality of sets of ribs 95,98, and 101 similar to ribs 71,74, and 77 of the sipping lid 20 to aid in gripping the nipple cover 28 in hand. The lower cap receiving portion 86 also includes an annular inwardly projecting ridge (not shown) which frictionally engages the ribs 71, 74, and 77 to frictionally retain the nipple cover 28 to the sipping lid 20, in the same manner as with the standard screw caps having rubber nipples. The nipple cover 28 keeps the nipple 32 clean during periods non-use when feeding of the infant is not being undertaken. The sealing disk 26 is also for use during periods between feedings, comprising a thin plastic, plastic film coated paper, or other such material which fits between the cap portion 29 with internal seal ring 44 and the externally threaded portion 47 of the baby bottle 23 thus providing liquid from leaving the baby bottle 23. The sipping lid 20 is unscrewed, the sealing disk 26 removed, and the sipping lid 20 reattached prior to feeding. The process is reversed to reattach sealing disk 26.

Sipping lid 20 and sealing disk 26 are made of materials approved by the Food and Drug Administration. The sipping lid is preferably an approved non-toxic plastic such as polypropylene. Such material is easy to clean and disinfect, and is also dishwasher safe. Sipping lids 20 are stackable, nesting together to save shelf space during storage and to lower shipping costs.

The sipping lid is the only sipping lid specifically designed for use with standard baby bottles 23 and may fit any such standard baby bottle. The sipping lid with baby bottle provides an easier transition to a sipping cup wherein the baby uses a rigid nipple but retains the familiar feel of the baby bottle. The diameter of the bottle is smaller and much easier to hold than a sipping cup. There is no need for handles as on many sipping cups. The use of standard baby bottles which are clear with liquid level markings allows the feeding parent to monitor the liquid intake of the baby. The sipping lid allows parents to use their baby bottles for a longer period of time saving storage space, money, and also making an easier transition period for the baby.

Whereas this invention is here illustrated and described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

I claim:

1. A sipping lid attached to a standard size baby bottle of the type having a hollow body to contain a liquid to be consumed by an infant and an externally threaded upper portion, the sipping lid comprising:
a cap portion having an internally threaded portion adapted to screw onto the externally threaded portion of the baby bottle;
a rigid nipple integral with said cap portion and having an end wall at a free end thereof distal from said cap portion, said nipple and said cap portion defining an internal cavity of the sipping lid, with a pair of small holes extending through said end wall into said internal cavity; and
wherein said cap portion engages the externally threaded portion of the hollow body of the baby bottle providing a seal between the sipping lid and the baby bottle, and wherein said holes both enter the infant's mouth simultaneously such that air cannot freely enter the baby bottle until suction by the infant is released.

2. The sipping lid according to claim 1, further comprising a sealing disk made of a thin resilient material, said sealing disk being adapted to be placed between the cap portion of the sipping lid and the externally threaded portion of the baby bottle and compressed when the sipping lid is screwed onto the externally threaded portion of the baby bottle to prevent liquid from leaving the baby bottle.

3. The sipping lid according to claim 2, wherein the thin resilient material of which the sealing disk is made comprises a material chosen from the group consisting of plastic and plastic film coated paper.

4. The sipping lid according to claim 1, wherein the nipple and cap portion are adapted for use with a standard baby bottle nipple cover as used with rubber nipples to keep said nipple clean during periods non-use when feeding of the infant is not being undertaken.

5. The sipping lid according to claim 1, wherein the cap portion includes an internal annular seal ring adapted to engage the externally threaded portion of the hollow body providing the seal between the sipping lid and the baby bottle.

6. The sipping lid according to claim 1, wherein the nipple is of a thin, curved configuration.

7. The sipping lid according to claim 6, wherein the nipple includes a curved front wall, an angled planar rear wall, a planar end wall, and a pair of angled, curved side walls all of which smoothly blend together such that no sharp corners are produced and to comfortably fit into the mouth of the infant.

8. The sipping lid according to claim 1, wherein the nipple is generally centered on and extends longitudinally from the cap portion is in a familiar position for the infant.

9. The sipping lid according to claim 1, wherein the holes are of a diameter of between about ½ mm and 1½ mm.

10. The sipping lid according to claim 1, wherein the cap portion includes a plurality of sets of ribs along an outer periphery of cap portion for gripping the sipping lid in hand during tightening and loosening from the baby bottle.

11. The sipping lid according to claim 1, wherein the sipping lid is made of a nontoxic plastic.

12. The sipping lid according to claim 2, wherein the sealing disk is made of a nontoxic material.

13. The sipping lid according to claim 1, wherein sipping lids are stackable wherein the nipples and cap portions nest together.

14. An infant sipping bottle device for use by infants, comprising:
a standard size baby bottle of the type having a hollow body to contain a liquid to be consumed by an infant and an externally threaded upper portion; and
a sipping lid attached to the a standard size baby bottle, said sipping lid which comprises a cap portion having an internally threaded portion adapted to screw onto said externally threaded portion of the baby bottle, a rigid nipple integral with said cap portion and having an end wall at a free end thereof distal from said cap portion, said nipple and said cap portion defining an internal cavity of the sipping lid, with a pair of small holes extending through said end wall into said internal cavity, and wherein said cap portion engages said externally threaded portion of said hollow body of said baby bottle providing a seal between the sipping lid and said baby bottle, and wherein said holes both enter the infant's mouth simultaneously such that air cannot freely enter said baby bottle until suction by the infant is released.
